(19) United States
(12) Patent Application Publication
(10) Pub. No.: US 2022/0174473 A1
(43) Pub. Date: Jun. 2, 2022

(54) System and Method for Registration During Device Onboarding

(71) Applicant: Minim Inc., Manchester, NH (US)

(72) Inventors: Alec Rooney, Eliot, ME (US); Denis Bakin, Lee, NH (US); Zachary Mattor, Manchester, NH (US); Nicole Zheng, New York, NY (US); Graham James Chynoweth, Manchester, NH (US)

(21) Appl. No.: 17/675,288

(22) Filed: Feb. 18, 2022

Related U.S. Application Data
(63) Continuation-in-part of application No. 17/315,458, filed on May 10, 2021.
Application No. 17/315,458 is a continuation-in-part of application No. 16/447,296, filed on Jun. 20, 2019, now Pat. No. 11,050,631.

(51) Int. Cl. H04W 8/18; H04W 60/04; H04L 9/40; H04W 12/40

(52) U.S. Cl. CPC H04W 8/183; H04W 12/40; H04L 63/0853; H04W 60/04

(57) ABSTRACT

In a method for registering a network device during onboarding to a wide area network (WAN) a mobile application receives user a scan of a readable tag affixed to the network device. wherein the user application comprises a user wallet. The application determines a network device identifier and credentials for a local area network (LAN) mapped to the readable tag. The LAN is created and associated with a user account. The LAN credentials, user account information, and the network device identifier are provided to a server by the mobile application. The server registers the LAN credentials and the network device identifier in a blockchain ledger under the user account information. The LAN credentials and network device identifier are added to a user wallet of the mobile application.

### CROSS-REFERENCE TO RELATED APPLICATIONS

This application is a continuation-in-part of and claims the benefit of co-pending U.S. non-provisional patent application Ser. No. 17/315,458, filed May 10, 2021, entitled “System and Method for Onboarding in a Wi-Fi Mesh Network,” which is a continuation-in-part of U.S. patent application Ser. No. 16/447,296, filed Jun. 20, 2019, entitled “System and Method for Onboarding in a Wi-Fi Mesh Network,” each of which is incorporated by reference herein in its entirety.

### FIELD OF THE INVENTION

The present invention relates to communication networks, and more particularly, is related to provisioning of a wireless network element.

### BACKGROUND OF THE INVENTION

Adding a network element to an existing communication network is known as “onboarding.” Common ways to onboard a mesh node to an existing Wi-Fi network include provisioning the mesh node with the Wi-Fi credentials using another type of radio (for example, Bluetooth), connecting to the mesh node using an advertised temporary service set identifier (SSID) and then configuring the mesh node to connect to an existing Wi-Fi network, and using Wi-Fi Protected Setup (WPS). While Bluetooth provides a positive end user experience, provisioning a mesh node involves the mesh node having another radio and/or component built into it, for example, a Bluetooth radio. Since many mesh nodes only have Wi-Fi radios, adding a Bluetooth radio increases the cost of the device.

Another common technique used for onboarding a mesh node to a Wi-Fi network involves the mesh node advertising a temporary Wi-Fi network of its own before the mesh node is configured via the temporary Wi-Fi network to join an existing Wi-Fi network. This can be done without an additional Bluetooth or other radio but may be is a cumbersome process for the user. The user connects a laptop or mobile phone to the custom SSID advertised by the mesh node first, the user configures the mesh node to connect to the existing Wi-Fi network which involves the user remembering network credentials (the SSID and password) for their existing Wi-Fi network and manually entering them into the mesh node via configuration screens.

Onboarding a mesh node to an existing Wi-Fi network with WPS involves pushing a button on both the Wi-Fi router and the mesh node to be added to the Wi-Fi network within a time window, typically a few minutes or less. Often there is little feedback if the WPS process is working, and the WPS process may fail due to timing issues. So, while WPS may seem simple it often leads to a very frustrating user experience due to lack of feedback and high rate of failure to pair. Therefore, there is a need in the industry to overcome the abovementioned shortcomings.

### SUMMARY OF THE INVENTION

Embodiments of the present invention provide a system and method for registration during device onboarding. Briefly described, the present invention is directed to a method for registering a network device during onboarding to a wide area network (WAN). A mobile application receives user a scan of a readable tag affixed to the network device. wherein the user application comprises a user wallet. The application determines a network device identifier and credentials for a local area network (LAN) mapped to the readable tag. The LAN is created and associated with a user account. The LAN credentials, user account information, and the network device identifier are provided to a server by the mobile application. The server registers the LAN credentials and the network device identifier in a blockchain ledger under the user account information. The LAN credentials and network device identifier are added to a user wallet of the mobile application.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The components in the drawings are not necessarily to scale, emphasis instead being placed upon clearly illustrating the principles of the present invention. The drawings illustrate embodiments of the invention and, together with the description, serve to explain the principles of the invention.

FIG. 1A is a schematic diagram of an exemplary network for a first exemplary embodiment method for onboarding a new device.

FIG. 1B is a schematic diagram the network of FIG. 1A during a first onboarding operation.

FIG. 1C is a schematic diagram the network of FIG. 1A during a second onboarding operation.

FIG. 1D is a schematic diagram the network of FIG. 1A during a third onboarding operation.

FIG. 2 is a schematic diagram the network of FIG. 1A after onboarding the new device.

FIG. 3 is a flowchart of a first exemplary embodiment of a method for provisioning a repeater device in a mesh network.

FIG. 4 is a flowchart of a first exemplary embodiment of a method for onboarding a network device to a Wi-Fi local area mesh network (WLAN) having a WLAN router and a mobile device.

FIG. 5 is a schematic diagram illustrating an example of a system for executing functionality of the present invention.

FIG. 6A is a schematic diagram of an exemplary network for a second exemplary embodiment method for onboarding a new device.

FIG. 6B is a schematic diagram the network of FIG. 6A during a first onboarding operation.

FIG. 6C is a schematic diagram the network of FIG. 6A during a second onboarding operation.

FIG. 6D is a schematic diagram the network of FIG. 6A during a third onboarding operation.

FIG. 7 is a schematic diagram of an exemplary third embodiment for onboarding a new device.

FIG. 8 is a flowchart of a second exemplary embodiment of a method for onboarding a network device to a WLAN.

FIG. 9 is a flowchart of a second exemplary embodiment of a method for onboarding a network device to a WLAN.

FIG. 10 is a flowchart of a third exemplary embodiment of a method for onboarding a network device to a WLAN.

FIG. 11 is a diagram of a fourth exemplary embodiment of the present invention of an onboarding process where a LAN and router are registered to a blockchain ledger.

FIG. 12A is a first diagram of a two-part diagram showing adding a mesh extender to the blockchain ledger of FIG. 11.

FIG. 12B is a second diagram continuing from FIG. 12B showing adding a mesh extender to the blockchain ledger of FIG. 11.

FIG. 13 is a schematic diagram a network of the fourth embodiment of FIG. 11.

### DETAILED DESCRIPTION

The following definitions are useful for interpreting terms applied to features of the embodiments disclosed herein, and are meant only to define elements within the disclosure.

As used within this disclosure, a “network credential” generally refers to one or more data fields used to admit a network element to communicate a communication network. For example, a network credential may include an SSID and/or password for the network.

As used within this disclosure, a “mesh network” refers to a local network topology in which the infrastructure nodes (i.e., routers, bridges, switches, repeaters, and other infrastructure devices) may connect directly, dynamically, and non-hierarchically to multiple network nodes and cooperate with one another to efficiently route data from/to other network nodes in a single or multi-hop fashion. While there are different types of mesh networks, unless otherwise specified, references to a mesh network within this document refer to a Wi-Fi mesh network.

As used within this disclosure, “Wi-Fi” refers to Wi-Fi a family of radio technologies that is commonly used for the wireless local area networking (WLAN) of devices which is based around the IEEE 802.11 family of standards. In general, Wi-Fi is used herein to distinguish from other types of wireless networks, for example, Bluetooth and Zigbee.

As used within this disclosure, a “direct connection” refers to a communication link between a first node and a second node of a mesh network where the first node and the second node may communicate without an intervening third node. Similarly, an “indirect connection” refers to a communication between the first node and the second node via one or more intervening nodes therebetween.

As used within this disclosure, a “scannable symbol” refers to a graphical symbol that may be read (“scanned”) with an optical device, for example, a camera or laser scanner, such that data associated with and/or encoded within the scannable symbol may be recovered. Examples of a scannable symbol include a barcode, a quick response (QR) code, or just numbers and letters.

As used within this disclosure, a “readable tag” refers to a machine readable passive and/or active electronic transponder device, for example, a radio-frequency identification (RFID) or NFC tag, that may be read with an electromagnetic tag reading device, such that data associated with and/or encoded within the readable tag may be recovered. Unlike a scannable symbol, a readable tag does not need to be within the line of sight of the reader, so it may be either affixed to or embedded in the tracked object. A readable tag is a type of automatic identification and data capture (AIDC).

As used within this disclosure, “REST” and “RESTful” refer to Representational State Transfer, a software architectural style that defines a set of constraints to be used for creating Web services. Web services that conform to the REST architectural style, called RESTful Web services (RWS), provide interoperability between computer systems on the Internet. Authentication for a RESTful configuration process uses a certificate, for example on a back end server. Remote configuration of network devices described herein may be performed using RESTful configuration, or an analogous technique.

As used within this disclosure, “blockchain” refers to a digital, public ledger that records online transactions. A blockchain includes a growable list of records, called blocks, which are linked together using cryptography. Each block contains a cryptographic hash of the previous block, a timestamp, and transaction data (generally represented as a Merkle tree). The timestamp indicates transaction data existed when the block was published in order to access its hash. As blocks each contain information about the block previous to it, they form a chain, with each additional block reinforcing the ones before it. Therefore, blockchains are resistant to modification of their data because once recorded, the data in any given block cannot be altered retroactively without altering all subsequent blocks.

As used within this disclosure a “wallet” refers to a software based blockchain wallet (similar to a cryptocurrency wallet) used to store private keys of an associated blockchain, providing the user access to participate in the blockchain.

As used within this disclosure, “the cloud” refers to one or many server devices (“cloud servers”) located remotely from a local network accessing the cloud. The local network is in communication with the internet, and the cloud servers generally communicate with the local network via the internet.

Reference will now be made in detail to embodiments of the present invention, examples of which are illustrated in the accompanying drawings. Wherever possible, the same reference numbers are used in the drawings and the description to refer to the same or like parts.

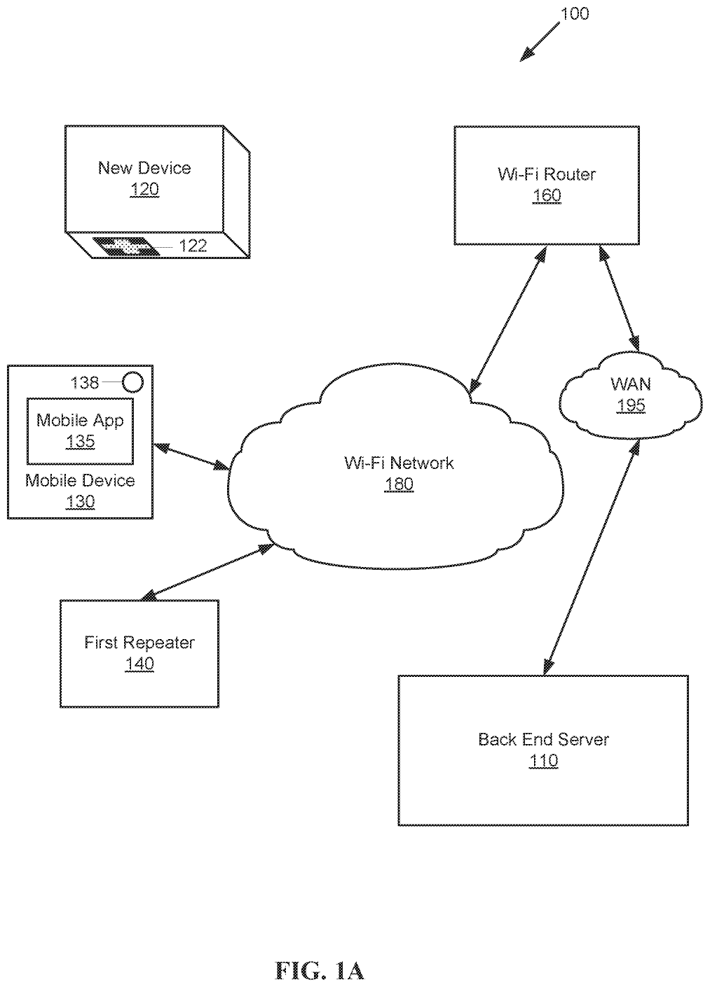

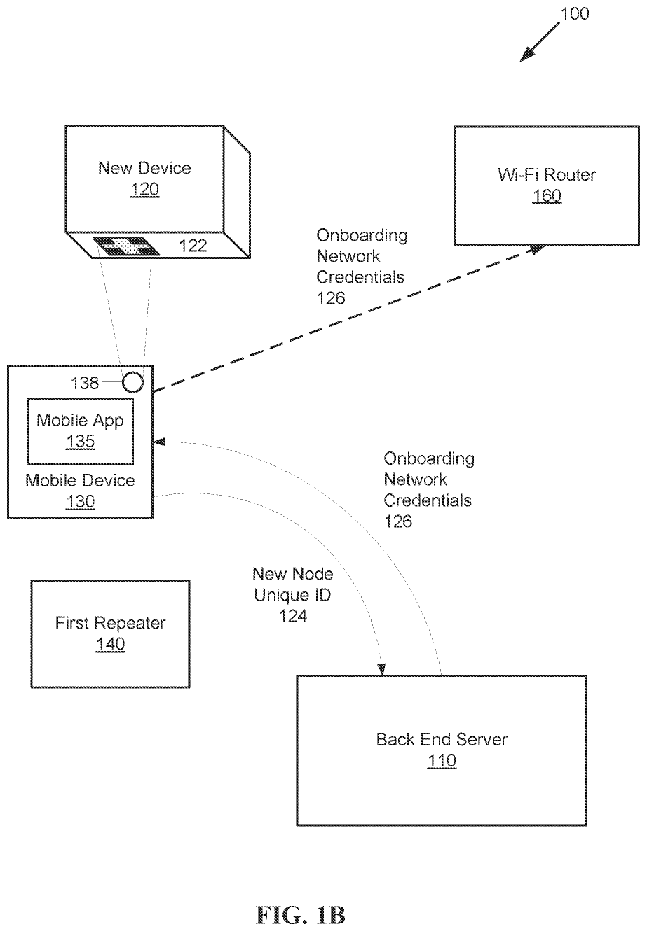

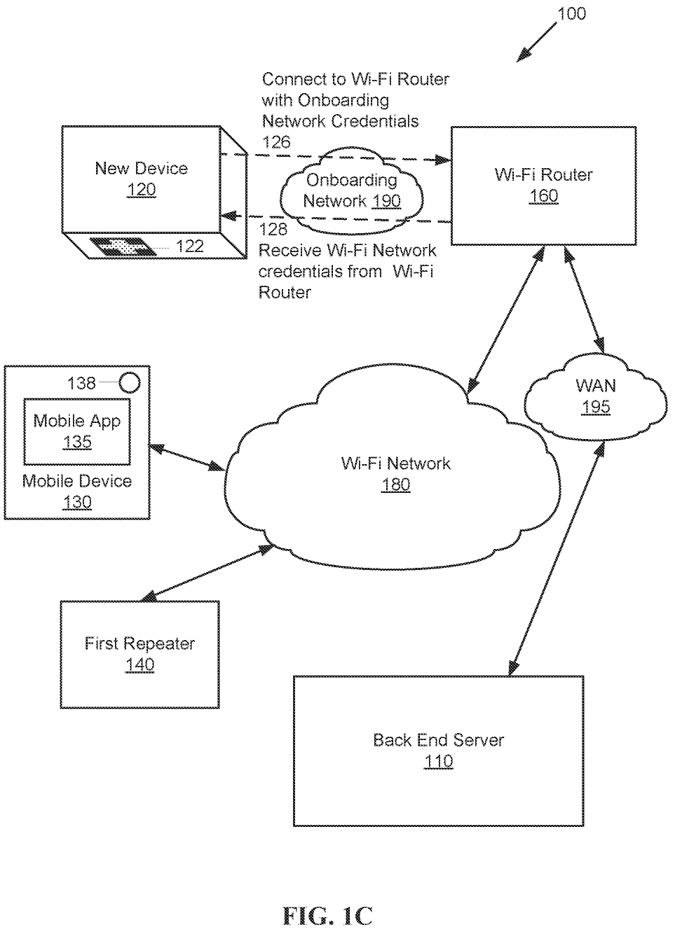

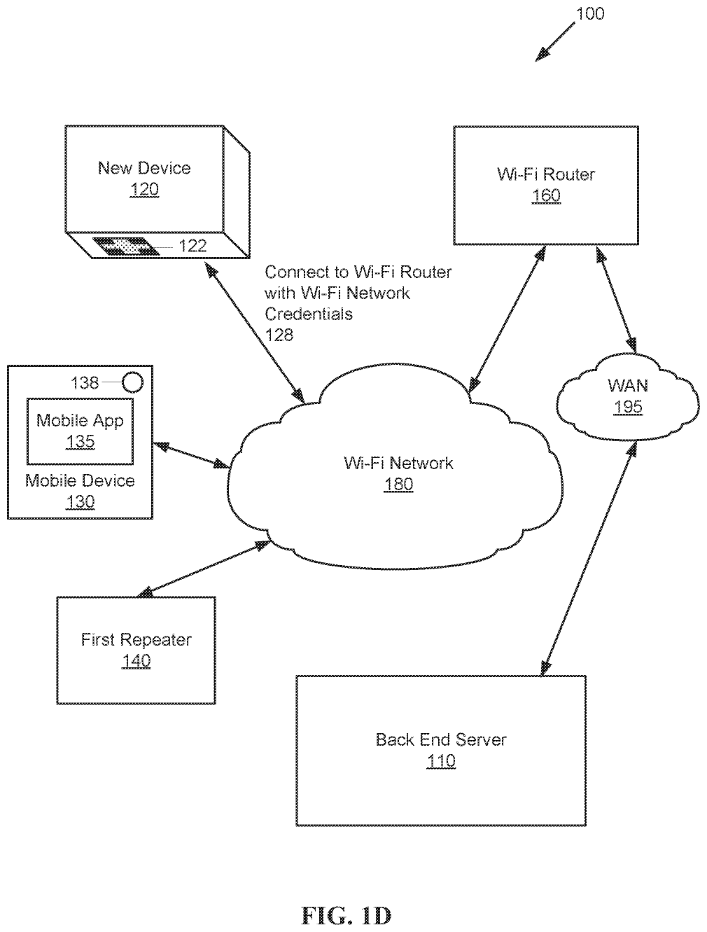

As shown by FIG. 1A, a first exemplary embodiment method provides for onboarding a mesh network node, here repeater device 120, to a system 100 having an existing mesh network, namely a Wi-Fi local area network 180 (also referred to herein as the WLAN 180). While the first embodiment refers to the onboarded device as a “repeater device” 120 for exemplary purposes, in other embodiments the onboarded device may be any type of Wi-Fi network element, not necessarily a repeater.

The system 100 includes a Wi-Fi router 160 configured to communicate with a plurality of devices in the Wi-Fi network, for example, a first repeater device 140 and a mobile device 130 such as a smart phone, tablet, or laptop. The Wi-Fi router 160 provides a connection to a wide area network (WAN) 195 for devices in the Wi-Fi network 180. The Wi-Fi router 160 may have a wired and/or wireless connection to the WAN 195. A back end server 110, for example, a cloud based server, communicates with devices in the Wi-Fi network 180 via the WAN 195. Note that descriptions of devices in the Wi-Fi network 180 communicating with the back end server 110 refer to communication channels via the Wi-Fi router 160 and WAN 195.

The following description refers to a user onboarding the repeater device 120. A mobile app 135 running on the mobile device 130 may be used to guide the user regarding appropriate placement of the repeater device 120, for example, indicating where to physically place the repeater device 120 according to Wi-Fi radio signal strength from the Wi-Fi router 160. During provisioning the repeater device 120 needs to be within Wi-Fi radio range to communicate with the Wi-Fi router 160. After the repeater device 120 is configured to communicate with the Wi-Fi network 180, the repeater device 120 may be moved to any location in the Wi-Fi network 180 where the repeater device 120 may make a multi-hop connection to the Wi-Fi router 160. When a suitable physical location is selected for the repeater device 120, the user scans an optical symbol 122 such as a QR code displayed by a surface of the repeater device 120, for example with a camera 138 of the mobile device 130 as shown by FIG. 1B. The optical symbol 122 includes encoded data providing a unique ID 124 to uniquely identifying the specific repeater device 120. For example, the unique ID 124 may include and/or be derived from a MAC address and/or serial number for the repeater device 120. The mobile app 135 may decode the unique ID from the optical symbol 122, and forward the unique ID 124 to the back end server 110. Alternatively, the mobile app 135 may pass the encoded data to the back end server 110 via the Wi-Fi network where the back end server 110 decodes the unique ID 124.

The unique ID 124 is mapped to a temporary network credential 126 specific to the repeater device 120. For example, the temporary network credential 126 may include an SSID and/or a password. As a further example, SSID may be assigned to be the MAC address of the repeater device, and an associated key/password may be mapped to the serial number of the repeater device 120. The repeater device 120 is pre-configured, for example, factory configured, to search for and connect to a Wi-Fi network using the temporary network credential 126 upon startup. The temporary network credential 126 is provided to the Wi-Fi router 160 by the mobile app 135, as shown by FIG. 1B. Alternatively, the temporary network credential 126 may be provided to the Wi-Fi router 160 by the back end server 110. For example, the back end server 110 may access an internally or externally stored lookup table mapping the unique ID 124 to the temporary network credential 126. The temporary network credential 126 may include a temporary network SSID and/or a temporary network password. The temporary network credential 126, temporary network SSID, and temporary network password are herein referred to respectively as the onboarding network credential 126, onboarding network SSID, and onboarding network password for a (temporary) onboarding network 190.

As shown by FIG. 1C, the Wi-Fi router 160 uses the received onboarding network credential 126 to establish an onboarding network 190. For example, the back end server 110 configures the Wi-Fi Router 160 with configuration commands via a RESTful protocol to add the onboarding network SSID from the onboarding network credential 126 so the repeater device 120 can connect to the onboarding network 190. For example, the repeater device 120 can connect to the onboarding network 190 and the router 160 via the first repeater 140 which acts as a virtual access point (VAP) for the onboarding network 190.

The repeater device 120 establishes communication with the Wi-Fi router 160 via the onboarding network 190. For example, the repeater device 120 may be factory configured to search for and connect to the onboarding network 190 using the onboarding network credential 126 in one of several scenarios: upon startup, if no other provisioned Wi-Fi network is detected, for example, after a timeout, after the repeater device 120 loses its connection to the Wi-Fi network 180, and/or after a factory reset of the repeater device 120, among others.

After the repeater device 120 is connected to the Wi-Fi router 160 via the onboarding network 190, the repeater device 120 receives a Wi-Fi network provisioning credential 128 via the onboarding network 190. For example, the repeater device 120 may request the Wi-Fi network provisioning credential 128 from the Wi-Fi router 160, or the repeater device 120 may connect to the back end server 110 via the Wi-Fi router 160 and the WAN 195 and request the Wi-Fi network provisioning credential 128 from the back end server 110. Alternatively, the repeater device 120 may use the onboarding network 190 to establish a communication channel with the mobile app 135 on the mobile device 130 via the Wi-Fi router 160 and the WAN 195 and request the Wi-Fi network provisioning credential 128 from the mobile app 135.

The repeater device 120 connects to the Wi-Fi router 160 via the Wi-Fi network 180 using the Wi-Fi network provisioning credential 128, as shown by FIG. 1D. Besides the Wi-Fi network provisioning credential 128, the repeater device 120 may receive other configuration parameters via the onboarding network 190 and/or the Wi-Fi network 180, for example from the mobile app 135 and/or the back end server 110, and then apply the received configuration parameters, for example, after a self-reset. In this manner, the repeater device 120 may automatically provision itself according to configuration parameters provided by the system 100 without interaction from the user beyond the scanning of the optical symbol 122 with the mobile device 130.

After the repeater device 120 is connected with and synchronized to the Wi-Fi router 160 via the Wi-Fi network 180, the Wi-Fi Router 160 may disable the onboarding network 190 (FIG. 1C), and the repeater device 120 may optionally delete the onboarding network credential 126 from the repeater device 120 memory.

When the repeater device 120 detects that it can talk to the back end server 110 via the onboarding network 190 the repeater device 120 can be fully managed by the back end server 110. The back end server 110 sends the new configuration for the repeater device 120 which includes the network credential 128 and as when the repeater device 120 receives that configuration it applies it and restarts its network, so it immediately leaves the onboarding network 190 and joins the Wi-Fi network 180. As discussed above, the repeater device 120 only reverts to using the old configuration and trying to join the onboarding network 190 if it loses its connection to the Wi-Fi network 180 or is factory reset, for example, if the configuration the repeater device received from the back end server 110 is deleted due to a factory reset.

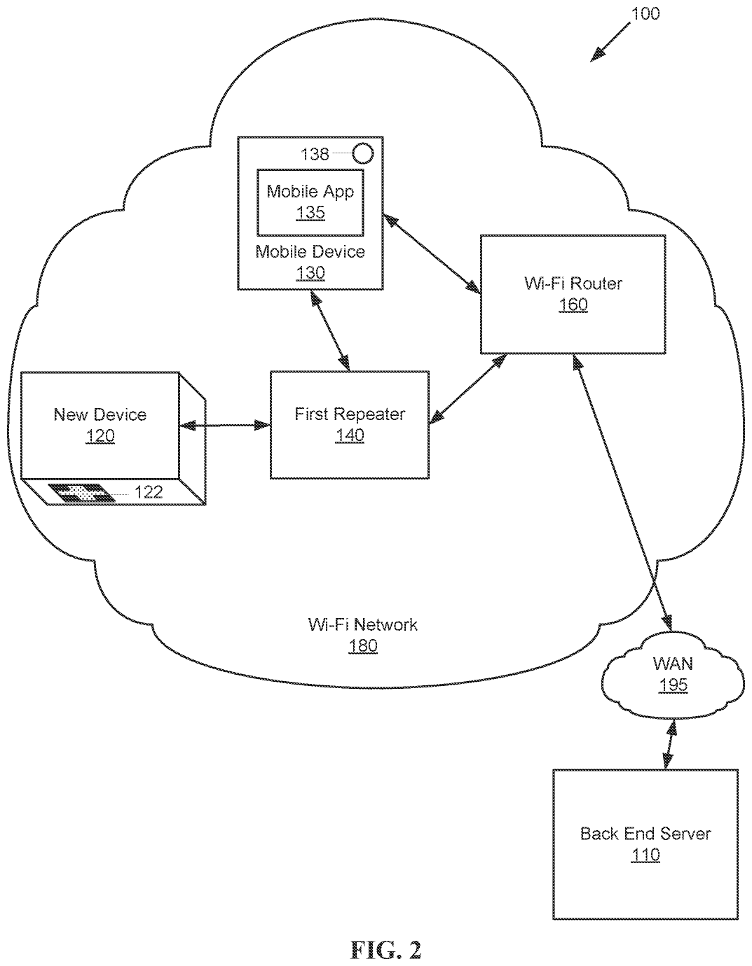

As shown by FIG. 2, after the repeater device 120 is configured to communicate with the Wi-Fi network 180, the repeater device 120 may be moved to any physical location in the Wi-Fi network 180 where the repeater device 120 may make a multi-hop connection to the Wi-Fi router 160. For example, as shown by FIG. 2, the repeater device 120 may connect to the Wi-Fi network 180 via the first repeater device 140, even if the repeater device 120 is out of radio range to connect directly to the Wi-Fi router 160. In this manner the repeater device 120 may be used to extend the range of the Wi-Fi network 180.

When a new repeater device 120 is manufactured, it is assigned a unique identifier 124, for example, a MAC address and/or a serial number. The manufacturer of the repeater device 120 maps the unique identifier 124 to a unique onboarding network credential 126, and adds a mapping of the unique identifier 124 and onboarding network credential 126 to a lookup table of mappings, for example, a database accessible to the back end server 110. The unique identifier may be displayed on an exterior surface of the repeater device 120, and/or encoded into a visually scannable optical symbol 122, for example, a QR code, and the optical symbol 122 is displayed upon an exterior surface of the repeater device 120. The new repeater device 120 is preconfigured to communicate via the onboarding network 190 according to the onboarding network credential 126.

As mentioned above, the Wi-Fi router 160 may be configured using a RESTful protocol. For example, the Wi-Fi router may be configured by the back end server 110 and/or the mobile app 135. The authentication for this mechanism is done using a certificate that exists on the back end server 110. An agent on the Wi-Fi router 160 verifies that it can talk to the back end server 110 by verifying that certificate and the communication is encrypted using https. Below is an example of a RESTful protocol exchange:
Router 160 sends to server 110: GET https://api.minim.co/v1/lan/:lan_id/commands server 110 responds: get router config command
Router 160 sends to server 110: GET https://api.minim.co/v1/lan/:lan_id/router_configs server 110 responds: a new configuration for the router and repeaters (for the whole Wi-Fi network 180) which includes the onboarding VAP
Router 160 sends to server 110: POST https://api.minim.co/v1/lan/:lan_id/router_configs which has the current running configuration of the router and repeaters (this allows the server 110 and the mobile app 135 to know that the provisioning network has been successfully configured on the router 160 and repeater devices 120, 140).

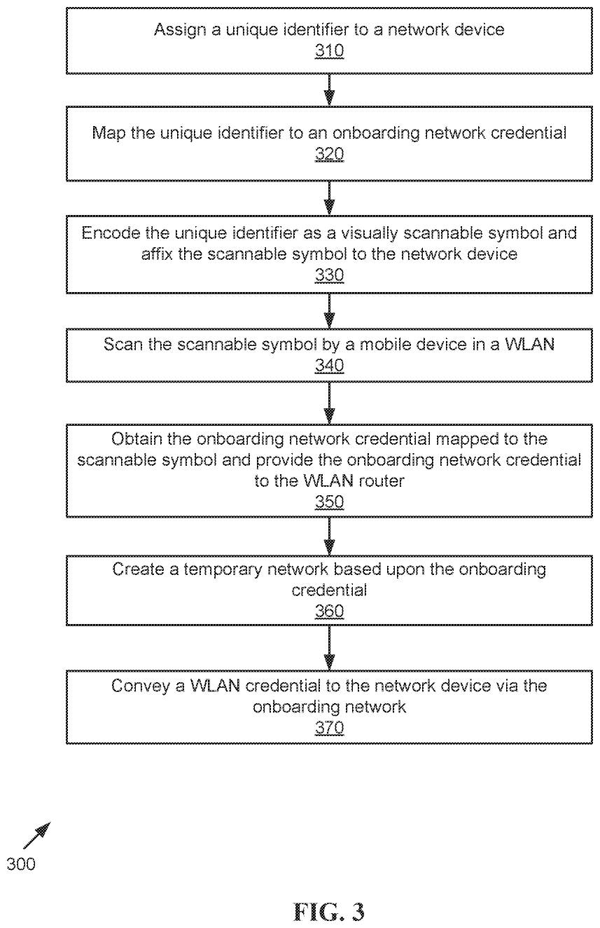

FIG. 3 is a flowchart of a first exemplary embodiment of a method 300 for onboarding a device to a Wi-Fi mesh local area network. It should be noted that any process descriptions or blocks in flowcharts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention. The method is described with reference to FIGS. 1A-1D.

A unique identifier 124 is assigned to a network device 120, for example a repeater device 120 as shown by block 310. For example, the unique identifier may be at least partially derived from a MAC address and/or a serial number for the network device 120. The unique identifier 124 is mapped to a unique onboarding network credential 126, as shown by block 320. The unique identifier is encoded in a scannable optical symbol 122, for example, a QR code, and the optical symbol 122 is displayed upon an exterior surface of the network device 120, as shown by block 330.

The optical symbol 122 is scanned by a mobile device in communication with a WLAN 180, as shown by block 340. The onboarding network credential 126 mapped to the optical symbol 122 is obtained, for example from a back end server 110, and the onboarding network credential 126 is provided to a router 160 for the WLAN, as shown by block 350. An onboarding network 190 is created by the WLAN router 160 based upon the onboarding network credential 126, as shown by block 360. The WLAN router 160 conveys a WLAN credential 128 to the network device 120 via the onboarding network 190, as shown by block 370.

Thereafter, the network device 120 uses the WLAN credential 128 to connect to the WLAN 180. The WLAN router 160 then optionally disables the onboarding network 190. It should be noted that while subsequent devices may be onboarded to the WLAN 180 in a similar fashion, each onboarding network credential 126 is preferably unique to each onboarding network 190 and each of the subsequent devices.

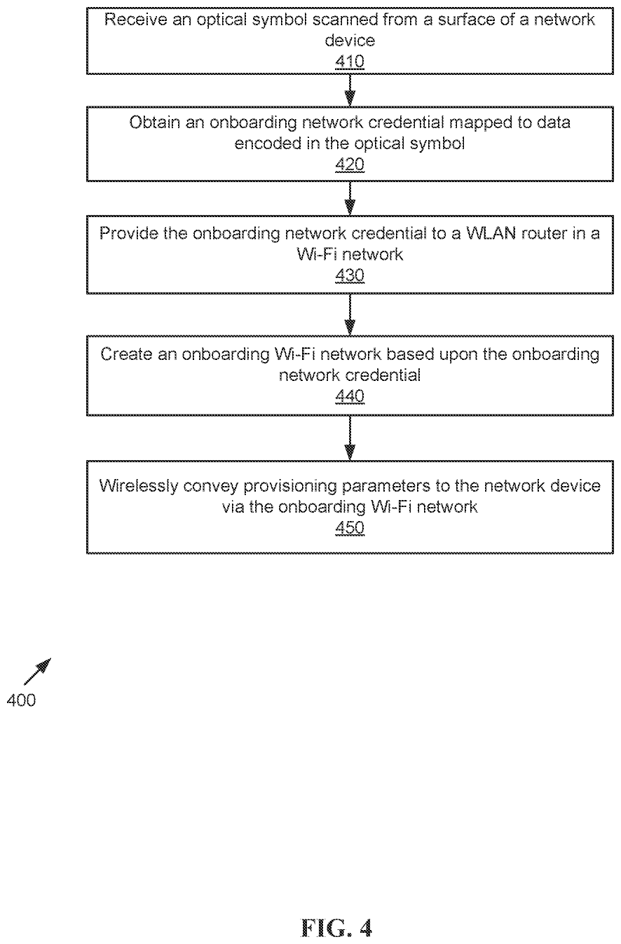

FIG. 4 is a flowchart of a second exemplary embodiment of a method 400 for onboarding a network device to a Wi-Fi local area mesh network (WLAN) having a WLAN router and a mobile device. A scanned optical symbol is received on the network device by the mobile device, as shown by block 410. For example, the mobile device may scan the optical symbol from the surface of the network device. The optical symbol may be letters/numbers, or may be a graphical symbol encoding data. An onboarding network credential mapped to data encoded in the optical symbol is obtained, as shown by block 420. For example, the data encoded in the optical symbol may be used to access the onboarding network credential from a database or lookup table.

The onboarding network credential is provided to the WLAN router, as shown by block 430. An onboarding Wi-Fi network based upon the onboarding network credential is created, for example by the WLAN router, as shown by block 440. The network device is pre-configured to communicate via the onboarding Wi-Fi network. Provisioning parameters are wirelessly conveyed to the network device via the onboarding Wi-Fi network, as shown by block 450. For example, the provisioning parameters may include WLAN credentials, so that the network device may join the WLAN.

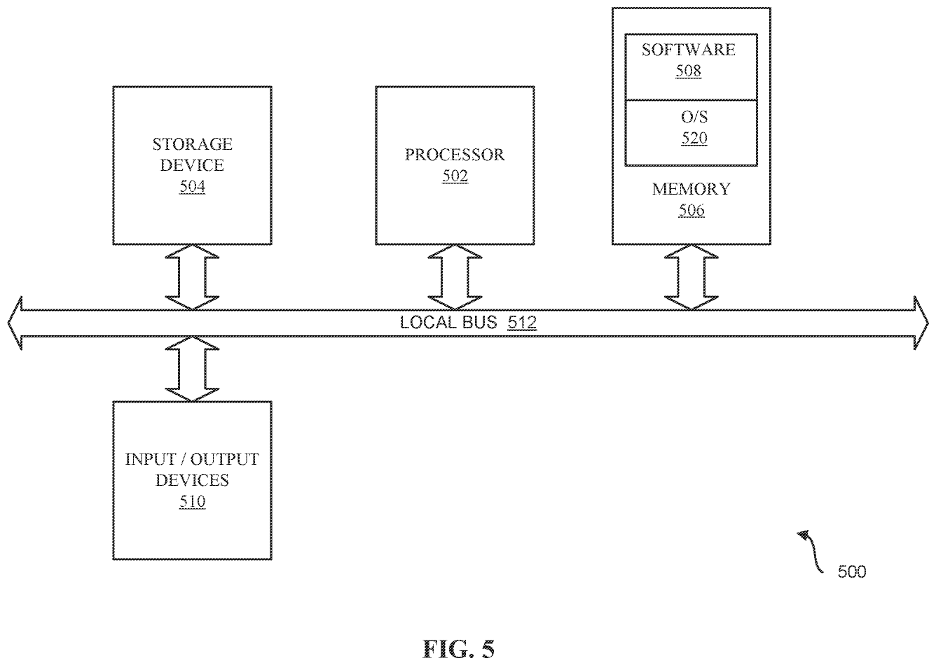

The present system for executing the functionality of the system 100 described in detail above and systems 600, 700 described in detail below may be a computer, an example of which is shown in the schematic diagram of FIG. 5. The system 500 contains a processor 502, a storage device 504, a memory 506 having software 508 stored therein that defines the abovementioned functionality, input and output (I/O) devices 510 (or peripherals), and a local bus, or local interface 512 allowing for communication within the system 500. The local interface 512 can be, for example but not limited to, one or more buses or other wired or wireless connections, as is known in the art. The local interface 512 may have additional elements, which are omitted for simplicity, such as controllers, buffers (caches), drivers, repeaters, and receivers, to enable communications. Further, the local interface 512 may include address, control, and/or data connections to enable appropriate communications among the aforementioned components.

The processor 502 is a hardware device for executing software, particularly that stored in the memory 506. The processor 502 can be any custom made or commercially available single core or multi-core processor, a central processing unit (CPU), an auxiliary processor among several processors associated with the present system 500, a semiconductor based microprocessor (in the form of a microchip or chip set), a macroprocessor, or generally any device for executing software instructions.

The memory 506 can include any one or combination of volatile memory elements (e.g., random access memory (RAM, such as DRAM, SRAM, SDRAM, etc.)) and nonvolatile memory elements (e.g., ROM, hard drive, tape, CDROM, etc.). Moreover, the memory 506 may incorporate electronic, magnetic, optical, and/or other types of storage media. Note that the memory 506 can have a distributed architecture, where various components are situated remotely from one another, but can be accessed by the processor 502.

The software 508 defines functionality performed by the system 500, in accordance with the present invention. The software 508 in the memory 506 may include one or more separate programs, each of which contains an ordered listing of executable instructions for implementing logical functions of the system 500, as described below. The memory 506 may contain an operating system (O/S) 520. The operating system essentially controls the execution of programs within the system 500 and provides scheduling, input-output control, file and data management, memory management, and communication control and related services.

The I/O devices 510 may include input devices, for example but not limited to, a keyboard, mouse, scanner, microphone, etc. Furthermore, the I/O devices 510 may also include output devices, for example but not limited to, a printer, display, etc. Finally, the I/O devices 510 may further include devices that communicate via both inputs and outputs, for instance but not limited to, a modulator/demodulator (modem; for accessing another device, system, or network), a radio frequency (RF) or other transceiver, a telephonic interface, a bridge, a router, or other device.

When the system 500 is in operation, the processor 502 is configured to execute the software 508 stored within the memory 506, to communicate data to and from the memory 506, and to generally control operations of the system 500 pursuant to the software 508, as explained above.

When the functionality of the system 500 is in operation, the processor 502 is configured to execute the software 508 stored within the memory 506, to communicate data to and from the memory 506, and to generally control operations of the system 500 pursuant to the software 508. The operating system 520 is read by the processor 502, perhaps buffered within the processor 502, and then executed.

When the system 500 is implemented in software 508, it should be noted that instructions for implementing the system 500 can be stored on any computer-readable medium for use by or in connection with any computer-related device, system, or method. Such a computer-readable medium may, in some embodiments, correspond to either or both the memory 506 or the storage device 504. In the context of this document, a computer-readable medium is an electronic, magnetic, optical, or other physical device or means that can contain or store a computer program for use by or in connection with a computer-related device, system, or method. Instructions for implementing the system can be embodied in any computer-readable medium for use by or in connection with the processor or other such instruction execution system, apparatus, or device. Although the processor 502 has been mentioned by way of example, such instruction execution system, apparatus, or device may, in some embodiments, be any computer-based system, processor-containing system, or other system that can fetch the instructions from the instruction execution system, apparatus, or device and execute the instructions. In the context of this document, a “computer-readable medium” can be any means that can store, communicate, propagate, or transport the program for use by or in connection with the processor or other such instruction execution system, apparatus, or device.

Such a computer-readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted, or otherwise processed in a suitable manner if necessary, and then stored in a computer memory.

In an alternative embodiment, where the system 500 is implemented in hardware, the system 500 can be implemented with any or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

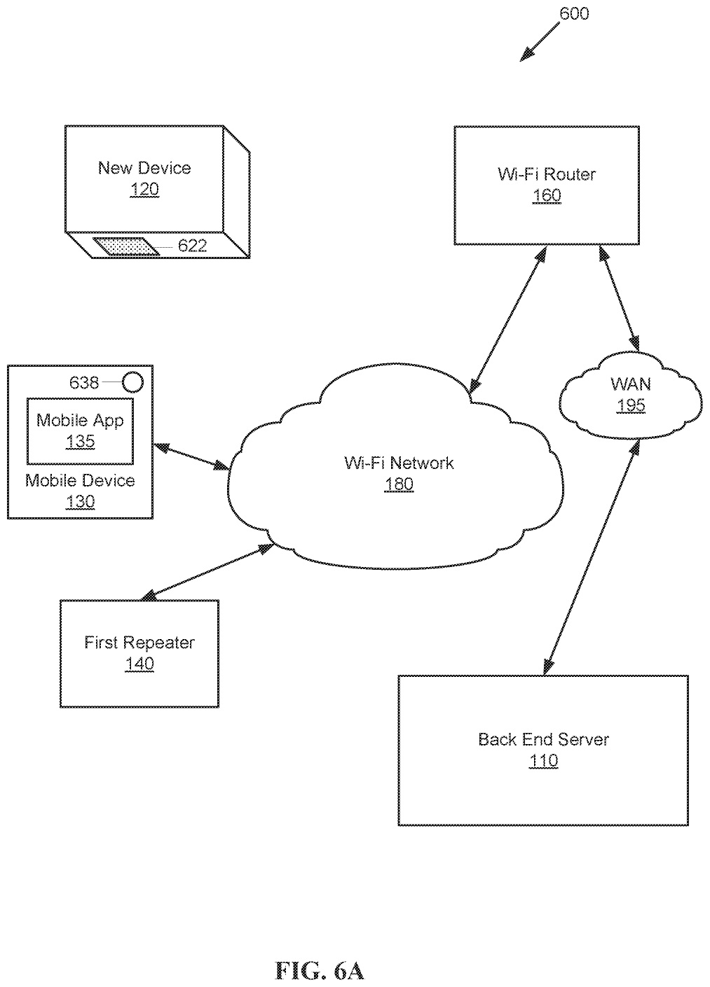

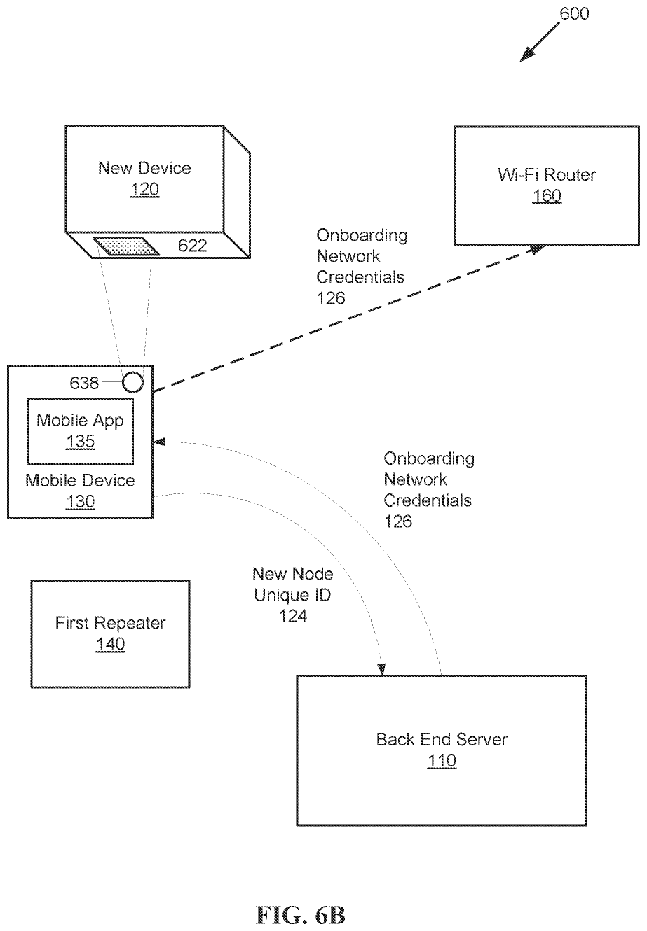

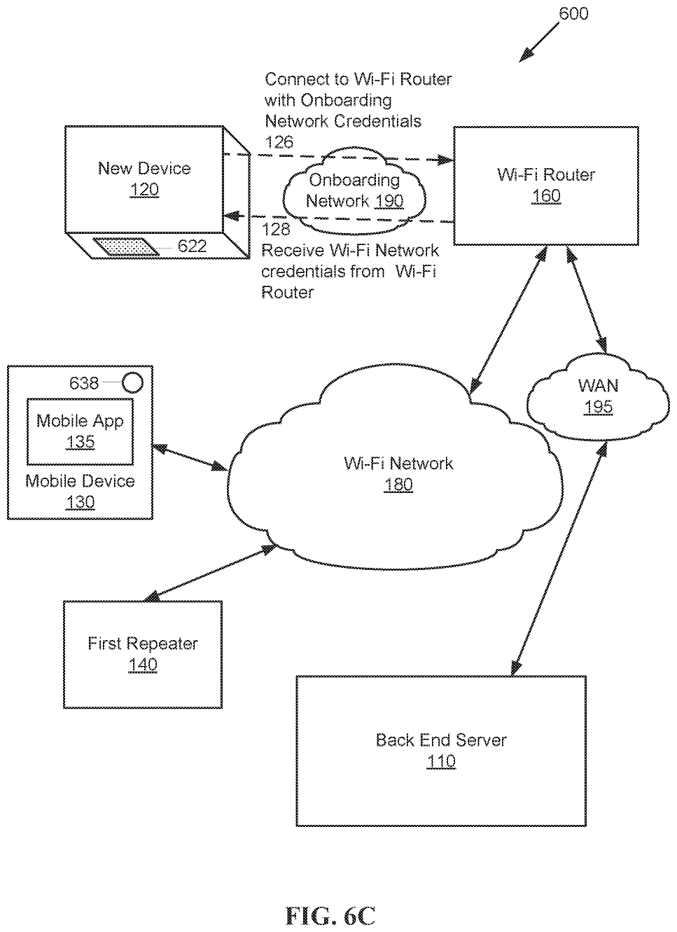

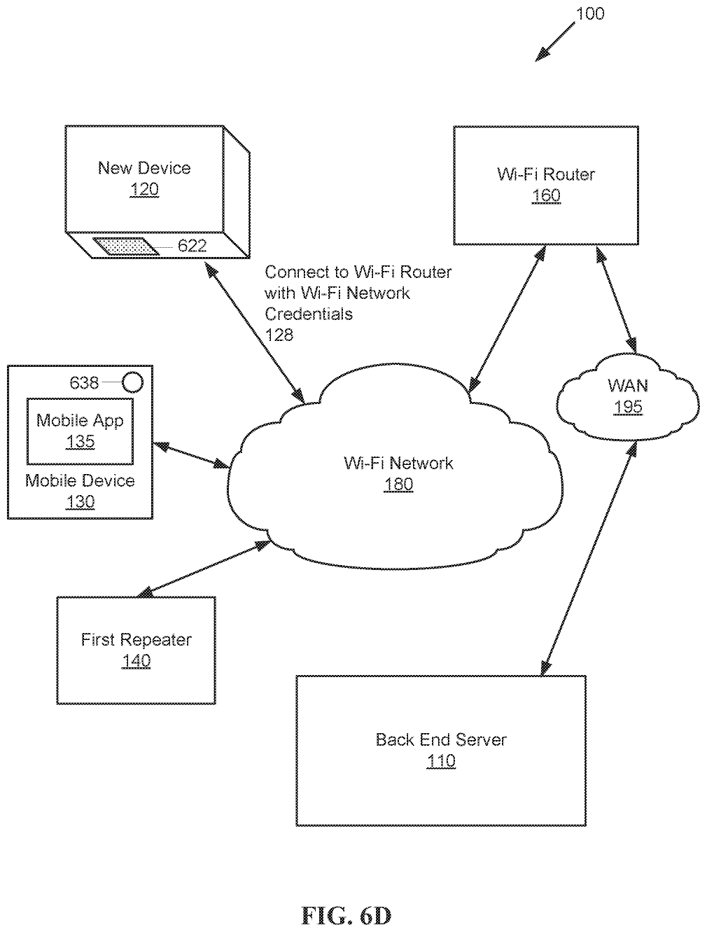

A second embodiment shown by FIGS. 6A-6D is substantially similar to the first embodiment described above and depicted by FIGS. 1A-1D, uses a readable tag 622, such as an RFID tag, NFC tag, or other non-optical scanning means instead of a scannable optical symbol 122 (FIG. 1A).

As shown by FIG. 6A, the second exemplary embodiment method provides for onboarding a mesh network node, here repeater device 120, to a system 600 having an existing mesh network, namely a Wi-Fi local area network 180 (also referred to herein as the WLAN 180). While the second embodiment refers to the onboarded device as a “repeater device” 120 for exemplary purposes, in other embodiments the onboarded device may be any type of Wi-Fi network element, not necessarily a repeater.

The system 600 includes a Wi-Fi router 160 configured to communicate with a plurality of devices in the Wi-Fi network, for example, a first repeater device 140 and a mobile device 130 such as an RFID tag reader, smart phone, tablet, or laptop. The Wi-Fi router 160 provides a connection to a wide area network (WAN) 195 for devices in the Wi-Fi network 180. The Wi-Fi router 160 may have a wired and/or wireless connection to the WAN 195. A back end server 110, for example, a cloud based server, communicates with devices in the Wi-Fi network 180 via the WAN 195. Note that descriptions of devices in the Wi-Fi network 180 communicating with the back end server 110 refer to communication channels via the Wi-Fi router 160 and WAN 195.

The following description refers to a user onboarding the repeater device 120. A mobile app 135 running on the mobile device 130 may be used to guide the user regarding appropriate placement of the repeater device 120, for example, indicating where to physically place the repeater device 120 according to Wi-Fi radio signal strength from the Wi-Fi router 160. During provisioning the repeater device 120 needs to be within Wi-Fi radio range to communicate with the Wi-Fi router 160. After the repeater device 120 is configured to communicate with the Wi-Fi network 180, the repeater device 120 may be moved to any location in the Wi-Fi network 180 where the repeater device 120 may make a multi-hop connection to the Wi-Fi router 160. When a suitable physical location is selected for the repeater device 120, the user reads a readable tag 622 such as an RFID tag embedded within or attached to a surface of the repeater device 120, for example with a tag reader 638 of the mobile device 130 as shown by FIG. 6B. Data read from the readable tag 622 provides a unique ID 124 to uniquely identifying the specific repeater device 120. For example, the unique ID 124 may include and/or be derived from a MAC address and/or serial number for the repeater device 120. The mobile app 135 may decode the unique ID from the readable tag, and forward the unique ID 124 to the back end server 110. Alternatively, the mobile app 135 may pass the encoded data to the back end server 110 via the Wi-Fi network where the back end server 110 decodes the unique ID 124.

The unique ID 124 is mapped to a temporary network credential 126 specific to the repeater device 120. For example, the temporary network credential 126 may include an SSID and/or a password. As a further example, SSID may be assigned to be the MAC address of the repeater device, and an associated key/password may be mapped to the serial number of the repeater device 120. The repeater device 120 is pre-configured, for example, factory configured, to search for and connect to a Wi-Fi network using the temporary network credential 126 upon startup. The temporary network credential 126 is provided to the Wi-Fi router 160 by the mobile app 135, as shown by FIG. 6B. Alternatively, the temporary network credential 126 may be provided to the Wi-Fi router 160 by the back end server 110. For example, the back end server 110 may access an internally or externally stored lookup table mapping the unique ID 124 to the temporary network credential 126. The temporary network credential 126 may include a temporary network SSID and/or a temporary network password. The temporary network credential 126, temporary network SSID, and temporary network password are herein referred to respectively as the onboarding network credential 126, onboarding network SSID, and onboarding network password for a (temporary) onboarding network 190.

As shown by FIG. 6C, the Wi-Fi router 160 uses the received onboarding network credential 126 to establish an onboarding network 190. For example, the back end server 110 configures the Wi-Fi Router 160 with configuration commands via a RESTful protocol to add the onboarding network SSID from the onboarding network credential 126 so the repeater device 120 can connect to the onboarding network 190. For example, the repeater device 120 can connect to the onboarding network 190 and the router 160 via the first repeater 140 which acts as a virtual access point (VAP) for the onboarding network 190.

The repeater device 120 establishes communication with the Wi-Fi router 160 via the onboarding network 190. For example, the repeater device 120 may be factory configured to search for and connect to the onboarding network 190 using the onboarding network credential 126 in one of several scenarios: upon startup, if no other provisioned Wi-Fi network is detected, for example, after a timeout, after the repeater device 120 loses its connection to the Wi-Fi network 180, and/or after a factory reset of the repeater device 120, among others.

After the repeater device 120 is connected to the Wi-Fi router 160 via the onboarding network 190, the repeater device 120 receives a Wi-Fi network provisioning credential 128 via the onboarding network 190. For example, the repeater device 120 may request the Wi-Fi network provisioning credential 128 from the Wi-Fi router 160, or the repeater device 120 may connect to the back end server 110 via the Wi-Fi router 160 and the WAN 195 and request the Wi-Fi network provisioning credential 128 from the back end server 110. Alternatively, the repeater device 120 may use the onboarding network 190 to establish a communication channel with the mobile app 135 on the mobile device 130 via the Wi-Fi router 160 and the WAN 195 and request the Wi-Fi network provisioning credential 128 from the mobile app 135.

The repeater device 120 connects to the Wi-Fi router 160 via the Wi-Fi network 180 using the Wi-Fi network provisioning credential 128, as shown by FIG. 6D. Besides the Wi-Fi network provisioning credential 128, the repeater device 120 may receive other configuration parameters via the onboarding network 190 and/or the Wi-Fi network 180, for example from the mobile app 135 and/or the back end server 110, and then apply the received configuration parameters, for example, after a self-reset. In this manner, the repeater device 120 may automatically provision itself according to configuration parameters provided by the system 600 without interaction from the user beyond the reading of the readable tag 622 by the mobile device 130.

After the repeater device 120 is connected with and synchronized to the Wi-Fi router 160 via the Wi-Fi network 180, the Wi-Fi Router 160 may disable the onboarding network 190 (FIG. 6C), and the repeater device 120 may optionally delete the onboarding network credential 126 from the repeater device 120 memory.

When the repeater device 120 detects that it can talk to the back end server 110 via the onboarding network 190 the repeater device 120 can be fully managed by the back end server 110. The back end server 110 sends the new configuration for the repeater device 120 which includes the network credential 128 and as when the repeater device 120 receives that configuration it applies it and restarts its network, so it immediately leaves the onboarding network 190 and joins the Wi-Fi network 180. As discussed above, the repeater device 120 only reverts to using the old configuration and trying to join the onboarding network 190 if it loses its connection to the Wi-Fi network 180 or is factory reset, for example, if the configuration the repeater device received from the back end server 110 is deleted due to a factory reset.

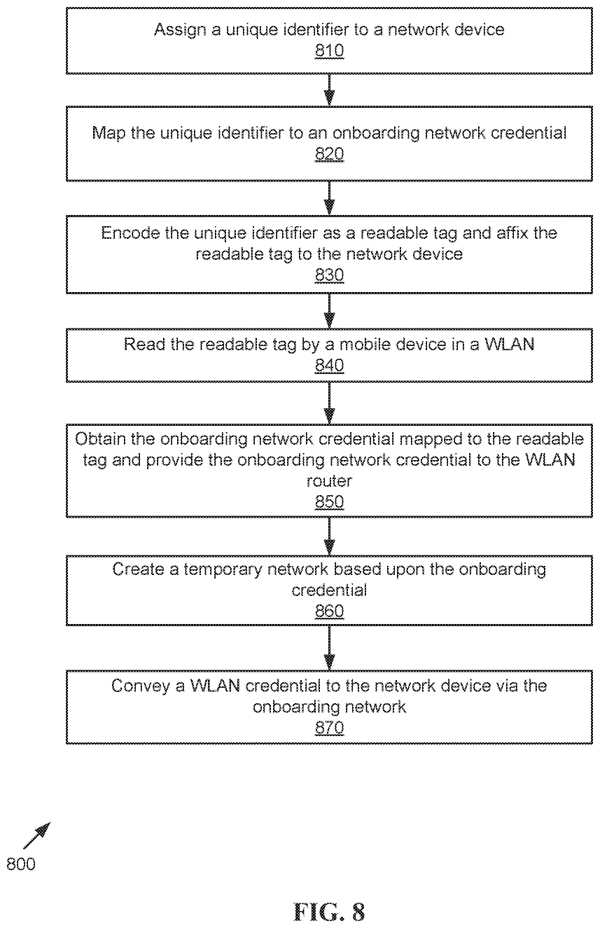

FIG. 8 is a flowchart of a first exemplary embodiment of a method 800 for onboarding a device to a Wi-Fi mesh local area network. The method is described with reference to FIGS. 6A-6D. A unique identifier 624 is assigned to a network device 620, for example a repeater device 620 as shown by block 310. For example, the unique identifier may be at least partially derived from a MAC address and/or a serial number for the network device 620. The unique identifier 624 is mapped to a unique onboarding network credential 626, as shown by block 320. The unique identifier is encoded in a readable tag 622, for example, an RFID tag, and the readable tag 622 is affixed to or incorporated within the network device 620, as shown by block 830.

The readable tag 622 is read by a mobile device in communication with a WLAN 680, as shown by block 840. The onboarding network credential 126 mapped to the readable tag 622 is obtained, for example from a back end server 610, and the onboarding network credential 626 is provided to a router 660 for the WLAN, as shown by block 850. An onboarding network 690 is created by the WLAN router 660 based upon the onboarding network credential 626, as shown by block 860. The WLAN router 660 conveys a WLAN credential 628 to the network device 620 via the onboarding network 690, as shown by block 870.

Thereafter, the network device 620 uses the WLAN credential 628 to connect to the WLAN 680. The WLAN router 660 then optionally disables the onboarding network 690. It should be noted that while subsequent devices may be onboarded to the WLAN 680 in a similar fashion, each onboarding network credential 626 is preferably unique to each onboarding network 690 and each of the subsequent devices.

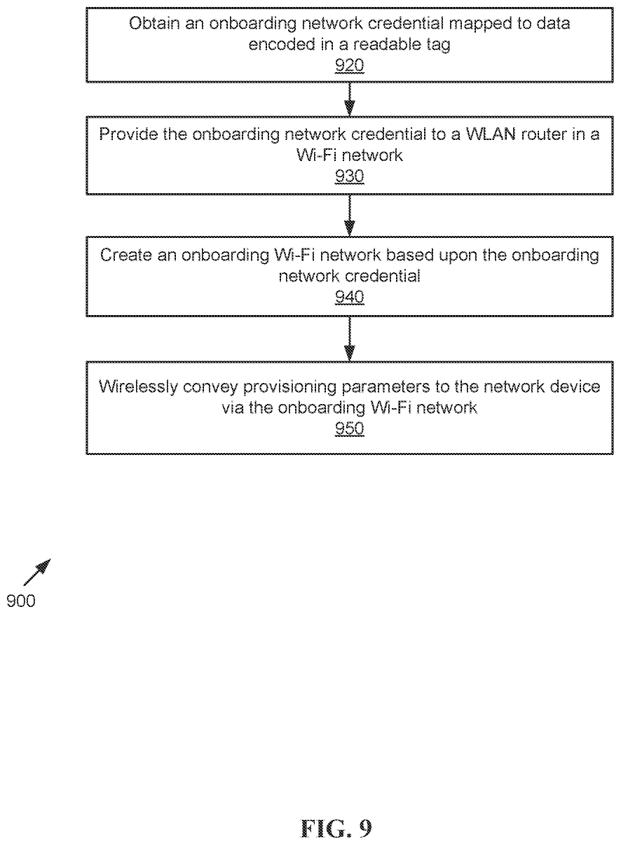

FIG. 9 is a flowchart of a second exemplary embodiment of a method 900 for onboarding a network device to a Wi-Fi local area mesh network (WLAN) having a WLAN router and a mobile device. An onboarding network credential mapped to data encoded in the readable tag is obtained, as shown by block 920. For example, the data encoded in the readable tag may be used to access the onboarding network credential from a database or lookup table.

The onboarding network credential is provided to the WLAN router, as shown by block 930. An onboarding Wi-Fi network based upon the onboarding network credential is created, for example by the WLAN router, as shown by block 940. The network device is pre-configured to communicate via the onboarding Wi-Fi network. Provisioning parameters are wirelessly conveyed to the network device via the onboarding Wi-Fi network, as shown by block 950. For example, the provisioning parameters may include WLAN credentials, so that the network device may join the WLAN.

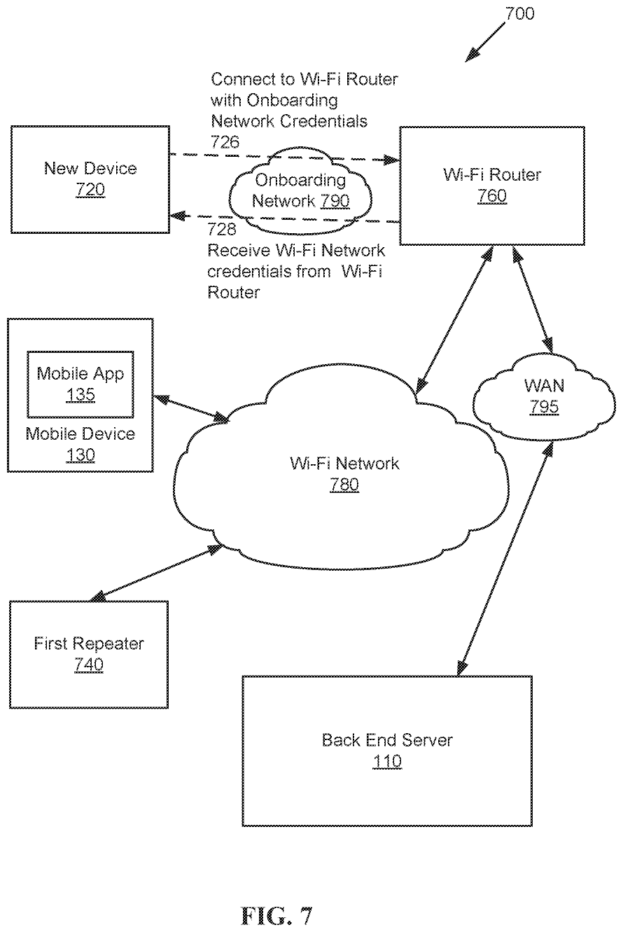

FIG. 7 is a schematic block diagram illustrating an exemplary third embodiment of an onboarding system 400. Here, a new device 720 shares information with a Wi-Fi router 760 of a Wi-Fi network 780 via basic service set identifiers (BSSID) advertised by the new device 720.

When the new device 720 is powered up, the new device 720 creates a virtual access point (VAP) with an SSID (service set identifier) of the VAP having a preamble to identify the new device 720 as a pre-provisioning satellite. For example, the preamble may be followed by a numeric key, such as sat-123456789 (note the SSID can be a maximum of 32 characters) such that the BSSID in the VAP advertisement indicates a MAC identifier of the new device 720.

The VAP is used to convey the same information (i.e., a mac address and key of the new device 720) to the Wi-Fi router 760 as the first embodiment (optical symbol) and the second embodiment (RFID tag) to signal to the router and backend server 110 and/or mobile app 135 on the mobile device 130. The server 110 uses the conveyed information to look up the onboarding credential for the router 760 to create the onboarding network 790.

The onboarding network 790 is similar to the onboarding network 190 (FIG. 1C) of the first and second embodiments created by the Wi-Fi router based on information published by the optical symbol 122 (FIG. 1C) or readable tag (FIG. 6C). Under the third embodiment, the new device 720 may simultaneously attempt to connect to the onboarding network 790 while publishing its BSSID. This is possible, for example, if new device 720 has two or more radios so a first radio is used to create the VAP and a second radio is used to connect to the onboarding network 790. Once the new device 720 is able to communicate with the Wi-Fi router 760, the onboarding of the new device 720 to the Wi-Fi network 780 proceeds substantially as described previously regarding the first and second embodiments.

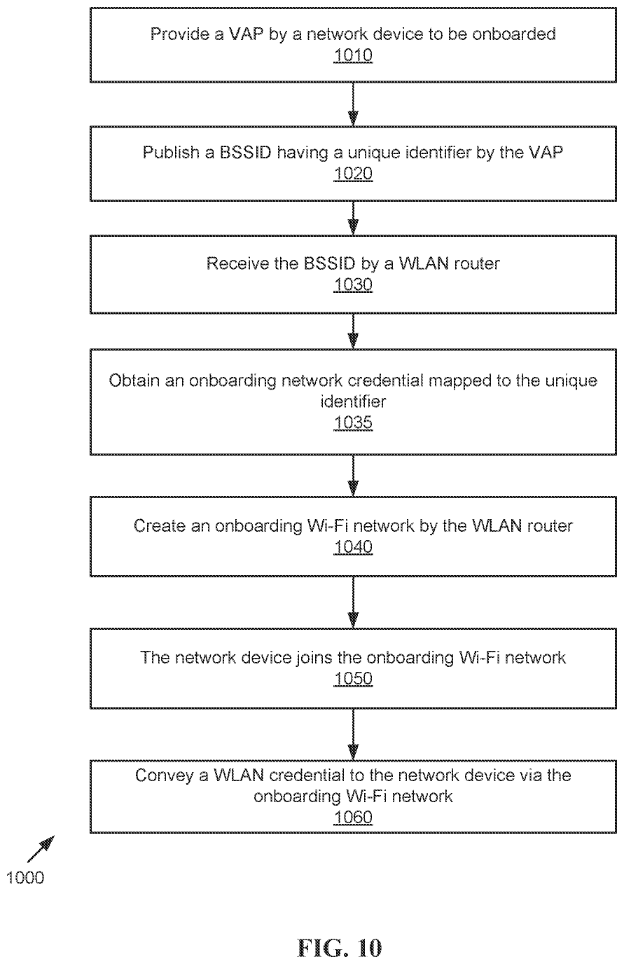

FIG. 10 is a flowchart of a third exemplary embodiment of a method 1000 for onboarding a network device to a WLAN. A virtual access point (VAP) is provided by a network device to be onboarded, as shown by block 1010. A basic service set identifier (BSSID) is published by the VAP, as shown by block 1020. The BSSID includes a preamble having unique identifier assigned to the network device. The BSSID is received by the WLAN router, as shown by block 1030.

The WLAN router obtains an onboarding network credential mapped to the unique identifier, as shown by block 1035. For example, the WLAN router may obtain the network credential from a backend server. The WLAN provides an onboarding network, as shown by block 1040. The network device joins the onboarding network by the network device, as shown by block 1050. The WLAN wirelessly conveys a credential for the WLAN to the network device via the onboarding Wi-Fi network, as shown by block 1060.

Under an exemplary fourth embodiment, Blockchain capabilities may be added to the mesh onboarding flow, providing additional functionality when a user registers a new router. As with the previous embodiments a new LAN is created for that user, but under the fourth embodiment both that router and the LAN are registered in the Blockchain Ledger under that users account. Here, the distributed Blockchain Ledger cryptographically associates that LAN and that Router with the user account. Likewise, if thereafter the user adds a mesh extender, the extender is also registered in the Blockchain Ledger and added to the user wallet, becoming visible in the mobile app. This enables a number of features based on this registration in MIN Blockchain. For example:

1. A second user (user B) wanting to access the internet via guest access on the LAN of a first user (user A) may obtain the access from user A via a microtransaction in the blockchain.

2. A third user (user C) who wants to evaluate the quality and security of guest access on the LAN of user A may inspect the relevant properties of that LAN in the blockchain ledger and know that those properties have not been tampered with and can be trusted e.g., security level, speed, etc.

3. User A can use re-encryption (see AFHG—https://eprint.iacr.org/2005/028.pdf also see https://www.researchgate.net/publication/327097502_Blockchain_Based_Secret-Data_Sharing_Model_for_Personal_Health_Record_System) to delegate access to their private data generated on their LAN and register that transaction in the blockchain ledger, creating an immutable record of that access and allowing control over access to their data.

4. User A has data ownership via automatic registration in the blockchain during onboarding by scanning QR code or NFC code. All data created by the LAN may be hashed and stored and then re-shared using re-encryption keys as in 3 above. Via the mobile app, user A can control which data is sensitive and should be stored securely and with audit capabilities enabled in the MIN Blockchain. User A can designate certain categories of data as categories that the user wants to protect and audit access to, e.g., websites visited and have the MIN platform automatically send data that matches that category to the blockchain.

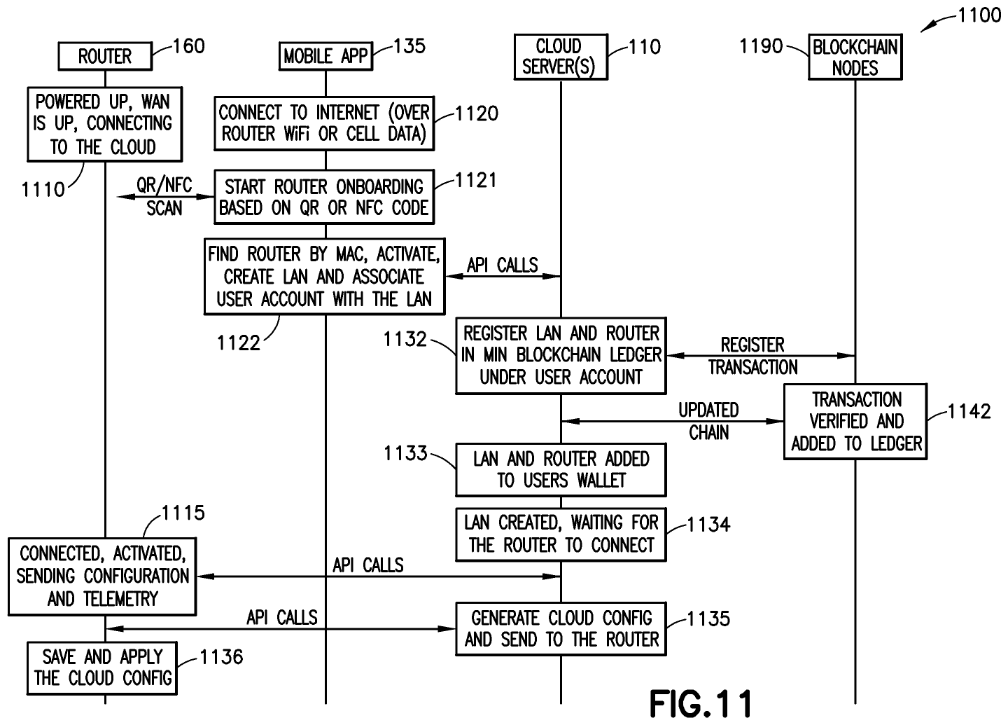

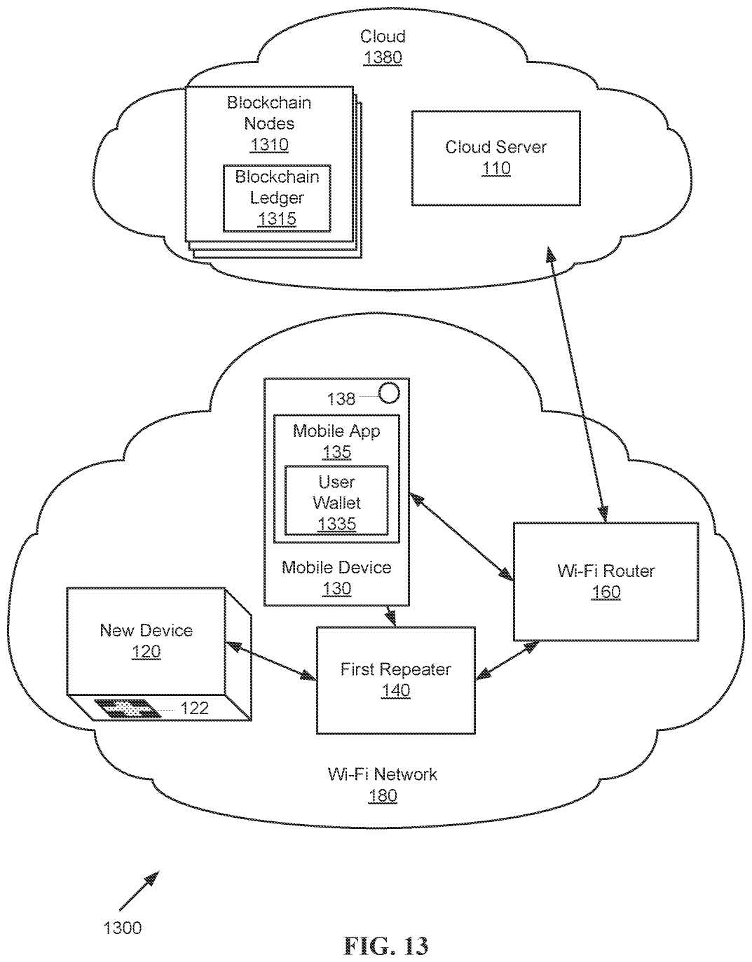

FIG. 11 is a flow diagram of the fourth exemplary embodiment of the present invention. In general, the fourth embodiment adds use of a blockchain ledger to any of the first, second, and third embodiments. The description of FIG. 11 refers to the diagram of an exemplary network in FIG. 13.

A router 160 for a wide area network is powered up and connected to the cloud 1380, as shown by block 1110. A user mobile app 135 connects to the interne, for example over WiFi or cellular data, as shown by block 1120. The mobile app 130 may be hosted by a user mobile device 130. Onboarding of the router 160 is started based on a QR or NFC code 122 scanned by the mobile app 135, as shown by block 1121. The mobile app 135 finds the router 160 using a MAC address of the router 160 obtained from the QR or NFC code, creates and activates a local area network (LAN) and associated the LAN with a user account, as shown by block 1122. The mobile app 135 communicates this with a cloud server 110, and the cloud server 110 registers the LAN and the router 160 in a blockchain ledger 1315 with blockchain nodes 1310 under an account of the user (“user account”), as shown by block 1132. An example of the data that the mobile app sends to the cloud may be:

POST /api.minim.com/lans/ {“mac”:”aa:bb:cc:dd:ee:ff”,
username: joesmith@example.com} which returns a lan_uuid.

An example of the data sent to add an extender may be:

POST /api.minim.com/unums/ {“lan_uuid”:
“abcdefghijklmn1234567”, “mac”:”aa:bb:cc:44:55:66”,
“key”: ”123456789”}

The blockchain nodes 1310 verify the registration transaction and add the registration data to the blockchain ledger 1315, as shown by block 1142. The cloud server 110 adds the LAN and router data to a user wallet 1335 in the mobile app 135 (FIG. 2), as shown by block 1133. The LAN having been created, the cloud server waits for the router 160 to connect to the LAN, as shown by block 1134. Once the router 160 has connected with the activated LAN, the router 160 sends configuration and telemetry data to the cloud server 110, for example, via API calls, as show by block 1115. The cloud server 110 generates a cloud configuration and sends the configuration to the router 160, as shown by block 1135. The router 130 saves and applies the cloud configuration received from the cloud server 110, as shown by block 1136. As a first example of a data exchange to set up an onboarding network the cloud server may send configuration data which can be key value pairs as follows:

wl1.1_ssid=onboard_aa:bb:cc:44:55:66
wl1.1_key=123456789

Alternatively, the cloud may send configuration data to setup a regular (not onboarding) network:

wl1_ssid=my_network
wl1_key=my_secret_key

It should be noted the functionality of blocks 1100, 1120-1122, 1134, 1115, 1135, and 1136 relate to functionality of the previously described first, second, and third embodiments.

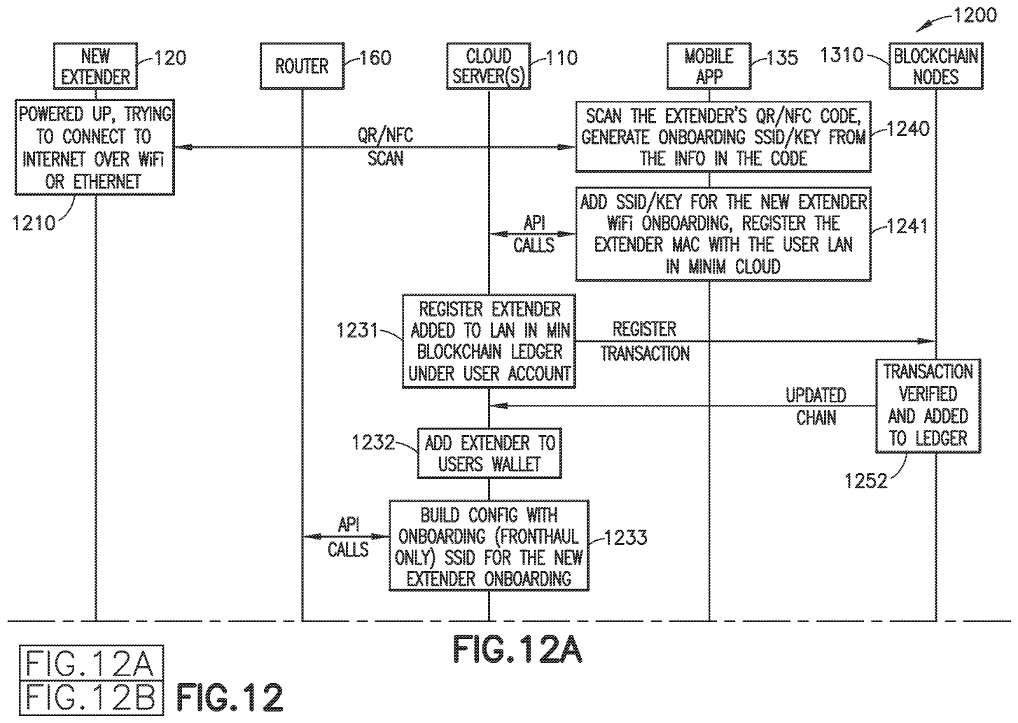

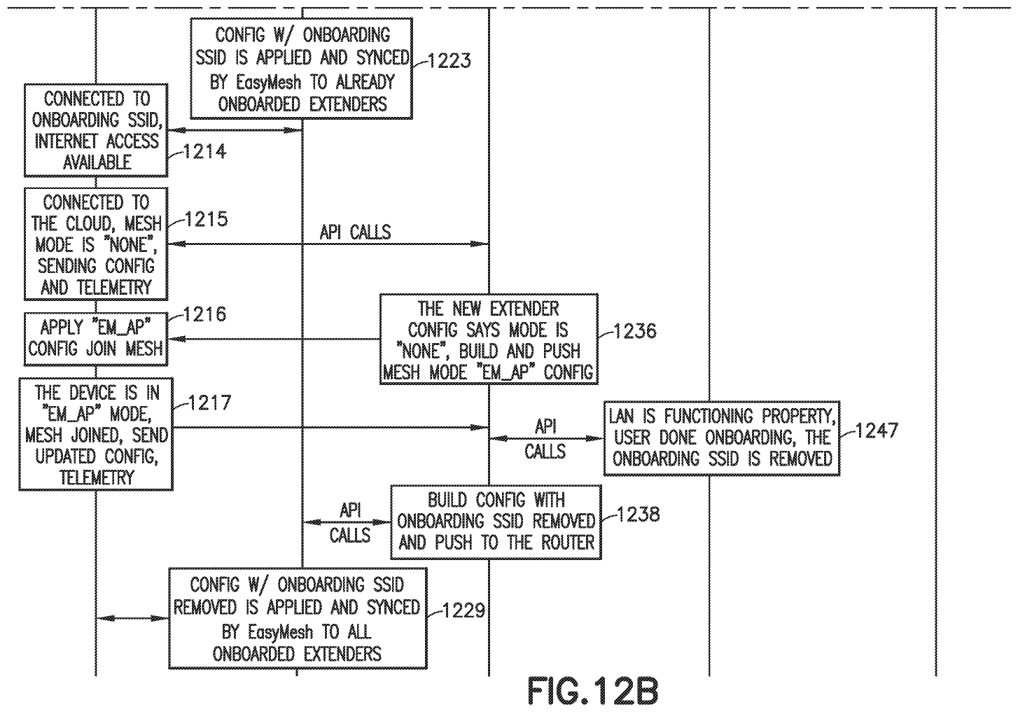

FIGS. 12A-B is a flow diagram of the process of adding a new extender to the network described in FIG. 11. The description of FIGS. 12A-B refers to the diagram of an exemplary network in FIG. 13.

A new network device, for example, an extender 120, is powered up and connected to the internet over WiFi or Ethernet, as shown by block 1210. Onboarding of the extender 120 is started based on a QR or NFC code 122 scanned by the mobile app 135, as shown by block 1140. The mobile app generates an onboarding SSID key from data read from the code 122. The mobile app 135 adds the SSID key for the new extender WiFi onboarding, and registers a MAC address for the new extender 120 and the user LAN with the cloud server 110, as shown by block 1241.

The cloud server 110 adds the extender to the blockchain ledger 1315 under the user account, as shown by block 1231. The cloud server 110 registers the transaction with the blockchain nodes 1310, and the blockchain nodes 1310 verifies and adds the transaction to the blockchain ledger 1315, as shown by block 1252. The blockchain nodes 1310 forward the updated chain information to the cloud server 110, and the cloud server 110 adds the extender 120 to the user wallet 1335.

The remaining description of FIGS. 12A-B pertains to features and actions previously described in the first, second, and third embodiments. The cloud server 110 builds a configuration with the onboarding SSID for the new extender onboarding LAN, as shown by block 1233. The router applies the configuration with the onboarding SSID, and the new extender is synchronized with any extenders previously added to the network, a shown by block 1223. The new extender 120 is connected to the onboarding SSID, and provided internet access, as shown by block 1214. The new extender 120 is connected to the cloud, with the mesh mode set to “none,” sending configuration and telemetry, as shown by block 1214. The cloud server 110 builds and pushes a mesh mode configuration to the new extender 120, as shown by block 1236. The new extender 120 is joins the mesh, as shown by block 1216. Here, with the new extender 120 part of the mesh, the mobile app 135 removes the onboarding SSID from the user data, as shown by block 1247. The cloud server 110 builds an updated network configuration with the onboarding SSID removed, and pushes the updated network configuration to the router 160, as shown by block 1238. The router 160 applies the updated network configuration (removing the onboarding SSID), as shown by block 1229, and the mesh extenders synchronize accordingly.

The blockchain functionality according to the fourth embodiment may be implemented on top of existing blockchain technology such as Ethereum or Hyperledger Fabric (see, for example, https://www.hyperledger.org/use/fabric, and https://ethereum.org/en/developers/).

The blockchain ledger may be created initially globally i.e., there is a single ledger or block chain that is the “trusted” chain. For example, the blockchain ledger may be created initially by a network provider or provider of network devices, and as users add devices to their network those transactions are recorded in the blockchain.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A method for registering a network device during onboarding to a wide area network (WAN), comprising the steps of:
receiving by an application a user a scan of a readable tag affixed to the network device, wherein the user application comprises a user wallet;
determining a network device identifier and credentials for a local area network (LAN) mapped to the readable tag;
creating the LAN;
associating a user account of the user with the LAN;
providing to a server by the application, the LAN credentials, user account information, and the network device identifier;
registering, by the server, the LAN credentials and the network device identifier in a blockchain ledger under the user account information; and
adding the LAN credentials and network device identifier to the user wallet.

2. The method of claim 1, wherein the network device comprises a Wi-Fi local area mesh network (WLAN) router.

3. The method of claim 1, therein the server comprises a cloud server.

4. The method of claim 1, wherein the user application is hosted on a mobile device of the user.

5. A method for registering a network device during onboarding to a Wi-Fi local area mesh network (WLAN) comprising a WLAN router, comprising the steps of:
Receiving, by an application, a user scan of a readable tag affixed to the network device;
determining a network device identifier and onboarding network credentials for an onboarding Wi-Fi network mapped to the readable tag;
registering the network device identifier and the onboarding network credentials under a user account on a server;
registering, by the server, the LAN credentials and the network device identifier in a blockchain ledger under the user account information; and
adding the network device identifier to a user wallet of the user application,
wherein the onboarding network credential comprises one or more data fields admitting the network device to communicate via the onboarding Wi-Fi network.

6. The method of claim 5, wherein the network device comprises a WLAN extender.

7. The method of claim 5, therein the server comprises a cloud server.

8. The method of claim 5, wherein the user application is hosted on a mobile device of the user.

9. A Wi-Fi mesh local area network (WLAN) system, comprising;
a network device associated with a unique identifier mapped to an onboarding network credential encoded in a readable tag affixed to the network device;
a WLAN router;
a mobile device comprising an application configured to communicate in the WLAN comprising a tag reader, a processor, and a memory configured to store non-transitory instructions that when executed by the processor perform the steps of:
reading the readable tag with the tag reader;
obtaining the onboarding network credential mapped to the readable tag;
registering the network device identifier and the onboarding LAN credentials under a user account on a cloud server; and
the cloud server configured to register the LAN credentials and the network device identifier in a blockchain ledger under the user account information,
wherein the mobile device is further configured to add the network device identifier to a user wallet on the mobile device application, and the onboarding network credential comprises one or more data fields admitting the network device to communicate via the onboarding Wi-Fi network.
